(19) United States
(12) Patent Application Publication
(10) Pub. No.: US 2007/0234342 A1
(43) Pub. Date: Oct. 4, 2007

(54) System and method for relocating running applications to topologically remotely located computing systems

(76) Inventors: John Thomas Flynn JR., Morgan Hill, CA (US); Mihaela Howie, Burlingame, CA (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/340,813

(22) Filed: Jan. 25, 2006

(51) Int. Cl. G06F 9/445

(52) U.S. Cl. 717/174

(57) ABSTRACT

A system and method for relocating running applications to topologically remotely located computing systems are provided. With the system and method, when an application is to be relocated, the application data is copied to a storage system of a topologically remotely located computing system which is outside the storage area network or cluster of the original computing system. In addition, a stateful checkpoint of the application is generated and copied to the topologically remotely located computing system. The copying of application data and checkpoint metadata may be performed using a peer-to-peer remote copy operation, for example. The application data and checkpoint metadata may further be copied to an instant copy, or flash copy, storage medium in order to generate a copy of checkpoint metadata for a recovery time point for the application.

### BACKGROUND

1. Technical Field

The present application relates generally to an improved data processing system and method. More specifically, the present application is directed to a system and method for relocating running applications to topologically remotely located computing systems.

2. Description of Related Art

High availability and disaster recovery are increasing more important in the information technology industry as today's society relies more heavily on electronic systems to perform daily activities. In this vein, it is becoming more important to be able to transfer a running application from one server computing device to another so as to ensure that the running application is available if a server computing system fails. Moreover, it is important to be able to relocate running applications in the event of a failure of a server computing system so that the running application may be recovered on a different computing system.

One solution for relocating running applications is provided by the VMotion™ software available from VMWare (an evaluation copy of VMotion™ is available from www.vmware.com/products/vc/vmotion.html). The VMotion™ software allows users to move live, running virtual machines from one physical server computing system to another physical server computing system connected to the same storage area network (SAN) while maintaining continuous service availability. The VMotion™ software is able to perform such relocation because of the virtualization of the disks in the storage area network.

However, VMotion™ is limited in that it requires that the entire virtual machine, which may comprise the operating system and a plurality of running applications, be moved to the new physical server computing device. There is no ability in the VMotion™ software to be able to move individual applications from one physical server computing device to another.

Moreover, VMotion™ is limited in that the movement of virtual machines can only be performed from one server computing device to another in the same SAN. Thus, VMotion cannot be used to move virtual machines to other server computing devices that are outside the SAN. This, in essence, places a network topology and geographical limitation on the server computing devices to which virtual machines may be moved using the VMotion™ software product.

Another solution for providing high availability and disaster recovery of running applications is the MetaCluster™ UC 3.0 software product available from Meiosys, Inc., which has been recently acquired by International Business Machines, Inc. As described in the article “Meiosys Releases MetaCluster UC Version 3.0,” available from PR Newswire at www.prnewswire.com, the MetaCluster™ software product is built upon a Service Oriented Architecture and embodies the latest generating of fine-grained virtualization technologies to enable dynamic data centers to provide preservation of service levels and infrastructure optimization on an application-agnostic basis under all load conditions.

Unlike coarse-grained virtual machine technologies and virtual machine mobility technologies, such as VMotion™ described above, which run at the operating system level and can only move an entire virtual machine at one time, the MetaCluster™ software product runs in a middleware layer between the operating system and the applications. MetaCluster™ provides a container technology which surrounds each application, delivering both resource isolation and machine-to-machine mobility for applications and application processes.

The MetaCluster™ software product's application virtualization and container technology enables relocation of applications both across physical and virtual machines. MetaCluster™ also provides substantial business intelligence which enables enterprises to set thresholds and define rules for managing the relocation of applications and application processes from machine to machine, both to address high availability and utilization business cases.

Deploying MetaCluster™ UC 3.0 for business critical applications allows applications to be virtualized very efficiently so that the performance impact is unnoticeable (typically under 1%). Virtualized applications may then be moved to the infrastructure best suited from a resource optimization and quality of service standpoint. Server capacity can be reassigned dynamically to achieve high levels of utilization without compromising performance. Since MetaCluster™ UC 3.0 enables the state and context of the application to be preserved during relocation, the relocation is both fast and transparent to the users of the applications.

MetaCluster™ UC 3.0 uses a transparent “checkpoint and restart” functionality for performing such relocation of applications within server clusters. When generating a checkpoint, the necessary stateful data and metadata for recreating the full state, connections and context of the running application are preserved for a particular point in time. This checkpoint may then be provided to another server computing device in the same cluster as the original server computing device. The server computing device to which the checkpoint is provided may then use the checkpoint information to restart the application, using application data available from a shared storage system of the cluster, and recreate the state, connections, and context of the application on the new server computing device.

While MetaCluster™ UC 3.0 allows relocation of individual applications within the same cluster, as opposed to requiring entire virtual machines to be relocated, MetaCluster™ is still limited to a localized cluster of server computing devices. That is, MetaCluster™ relies on the ability of all of the server computing devices having access to a shared storage system for accessing application data. Thus, MetaCluster™ does not allow movement or relocation of running applications outside of the server cluster. Again this limits the network topology and geographical locations of computing devices to which running applications may be relocated.

### SUMMARY

In view of the above, it would be beneficial to have a system, method and computer program product for relocation of running applications to topologically and/or geographically remotely located computing devices. Moreover, it would be beneficial to have a system, method, and computer program product for relocating running applications to computing devices outside a storage area network or cluster of computing devices in which the running applications were previously present. Furthermore, it would be beneficial to have such a relocation mechanism that allows for instant recovery of the application to a last checkpoint for disaster recovery. The illustrative embodiments described hereafter provide such a system, method and computer program product.

With the mechanisms of the illustrative embodiments, when an application is to be relocated, the application data is copied to a storage system of a topologically remotely located computing system. The copying of application data may be performed using mirroring technology, such as a peer-to-peer remote copy operation, for example. This application data may further be copied to an instant copy, or flash copy, storage medium in order to generate a copy of application data for a recovery time point for the application.

Being topologically remotely located, in the present description, refers to the computing system being outside the cluster or storage area network of the computing device from which the running application is being relocated. In many cases a topologically remotely located computing system may be geographically remotely located as well, but this is not required for the computing system to be topologically remotely located. Rather, the topologically remotely located computing system need only be remotely located in terms of the network topology connecting the various computing devices.

In addition to copying the application data, a stateful checkpoint of the application is generated and stored to a storage medium. The stateful checkpoint comprises a set of metadata describing the current state of the application at the time that the checkpoint is generated. Preferably, the checkpoint is generated at substantially the same time as the copying of the application data so as to ensure that the state of the application as represented by the checkpoint metadata matches the application data.

The checkpoint metadata may be copied to the same or different storage system associated with the topologically remotely located computing system in a similar manner as the application data. For example, a peer-to-peer remote copy operation may be performed on the checkpoint metadata to copy the checkpoint metadata to the remotely located storage system. This checkpoint metadata may further be copied to an instant copy, or flash copy, storage medium in order to generate a copy of checkpoint metadata for a recovery time point for the application.

In one illustrative embodiment, the MetaCluster™ product may be used to generate checkpoint metadata for the application as if the application were being relocated within a local cluster of server computing devices. In such an illustrative embodiment, the checkpoint metadata and application data may be relocated to a topologically remotely located computing system using the Peer-to-Peer Remote Copy (PPRC) or Peer-to-Peer Remote Copy Extended Distance (PPRC-XD) product available from International Business Machines, Inc. of Armonk, N.Y. These products are also referred to by the names Metro Mirror™ (PPRC) and Global Copy™ (PPRC-XD). The recovery time point copies of the application data and checkpoint metadata may be generated, for example, using the FlashCopy™ product available from International Business Machines, Inc.

In one illustrative embodiment, a computer program product comprising a computer usable medium having a computer readable program is provided. The computer readable program, when executed on a computing device, causes the computing device to remotely copy application data for a running application to a topologically remotely located computing system and generate an application checkpoint comprising checkpoint metadata that represents a same point in time as the copy of the application data. The computer readable program may further causes the computing device to remotely copy the checkpoint metadata to the topologically remotely located computing system and relocate the running application to the topologically remotely located computing system by initiating the running application on the topologically remotely located computing system using the copy of the application data and the checkpoint metadata. The computer readable program may cause the computing device to repeatedly perform the operations of remotely copying application data for a running application to a topologically remotely located computing system, generating an application checkpoint comprising checkpoint metadata that represents a same point in time as the copy of the application data, and remotely copying the checkpoint metadata to the topologically remotely located computing system.

The computer readable program may further cause the computing device to remotely copy application data to a topologically remotely located computing system and remotely copy the checkpoint metadata to the topologically remotely located computing system using a peer-to-peer remote copy operation. The peer-to-peer remote copy operation may be an asynchronous copy operation. The peer-to-peer remote copy operation may be a non-synchronous asynchronous copy operation. The topologically remotely located computing system may be geographically remotely located from a source computing system that initially is running the running application.

The remotely copied application data and remotely copied checkpoint metadata may be copied from a storage system associated with the topologically remotely located computing system to at least one other storage device to generate a recovery checkpoint. The copying of the remotely copied application data and checkpoint metadata to at least one other storage device may be performed using an instant copy operation.

The topologically remotely located computing system may query storage controllers associated with a source computing system from which the application data and checkpoint metadata are remotely copied and the topologically remotely located computing system to determine if all of the application data and checkpoint metadata has been remotely copied. The topologically remotely located computing system may perform the copying of the remotely copied application data to the at least one other storage device only if all of the application data has been remotely copied to the topologically remotely located computing system. The topologically remotely located computing system may perform the copying of the remotely copied checkpoint metadata to the at least one other storage device only if all of the checkpoint metadata has been remotely copied to the topologically remotely located computing system.

The computer readable program may further cause the computing device to detect a failure of the topologically remotely located computing device during a remote copy operation. The computer readable program may also cause the computing device to recover a state of the running application at a last checkpoint based on the remotely copied application data and remotely copied checkpoint metadata present in storage devices associated with the topologically remotely located computing device.

The computing device may generate the application checkpoint at substantially a same time as when the computing device remotely copies the application data for the running application. The computing device may be one of a storage area network control computing device or a server cluster control computing device.

In another illustrative embodiment, an apparatus is provided that comprises a processor and a memory coupled to the processor. The memory may contain instructions which, when executed by the processor, cause the processor to perform one or more of the operations described above with regard to the computer readable program.

In a further illustrative embodiment, a method, in a data processing system, is provided for relocating a running application from a source computing device to a topologically remotely located computing system. The method may comprise one or more of the operations described above with regard to the computer readable program.

In yet another illustrative embodiment, a system is provided for relocating a running application. The system may comprise at least one network, a first computing system coupled to the network, and a second computing system coupled to the network. The second computing system may be topologically remotely located from the first computing system. The first computing system may remotely copy application data for a running application on the first computing system to the second computing system and generate an application checkpoint comprising checkpoint metadata that represents a same point in time as the copy of the application data. The first computing system may further remotely copy the checkpoint metadata to the second computing system and relocate the running application to the second computing system by initiating the running application on the second computing system using the copy of the application data and the checkpoint metadata.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a distributed data processing system in which exemplary aspects of an illustrative embodiment may be implemented;

FIG. 2 is an exemplary block diagram of a server computing device in which exemplary aspects of an illustrative embodiment may be implemented;

FIG. 3 is an exemplary block diagram illustrating the peer-to-peer remote copy operation in accordance with one illustrative embodiment;

FIG. 4 is an exemplary diagram illustrating an operation for relocating a running application in accordance with one illustrative embodiment;

FIG. 5 is an exemplary block diagram of the primary operational components of a running application relocation mechanism in accordance with an illustrative embodiment;

FIG. 6 is an exemplary table illustrating the primary steps in performing a relocation of a running application in accordance with an illustrative embodiment;

FIGS. 7A and 7B are an exemplary table illustrating the primary steps in recovering a last checkpoint of a running application in response to a failure during a relocation operation in accordance with an illustrative embodiment; and

FIG. 8 is a flowchart outlining an exemplary operation for relocating a running application to a topologically remotely located computing system in accordance with an illustrative embodiment.

### DETAILED DESCRIPTION OF THE PREFERRED EMBODIMENTS

The illustrative embodiments set forth herein provide mechanisms for relocating running applications to topologically, and often times geographically, remotely located computing systems, i.e. computing systems that are not within the storage area network or cluster of the computing system from which the running application is being located. As such, the mechanisms of the illustrative embodiments are preferably implemented in a distributed data processing environment.

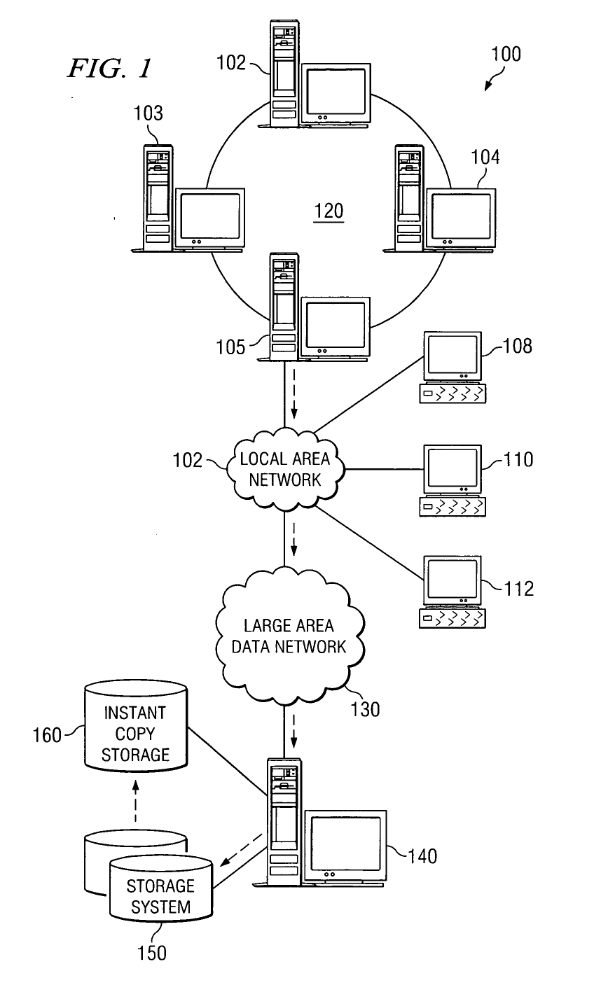

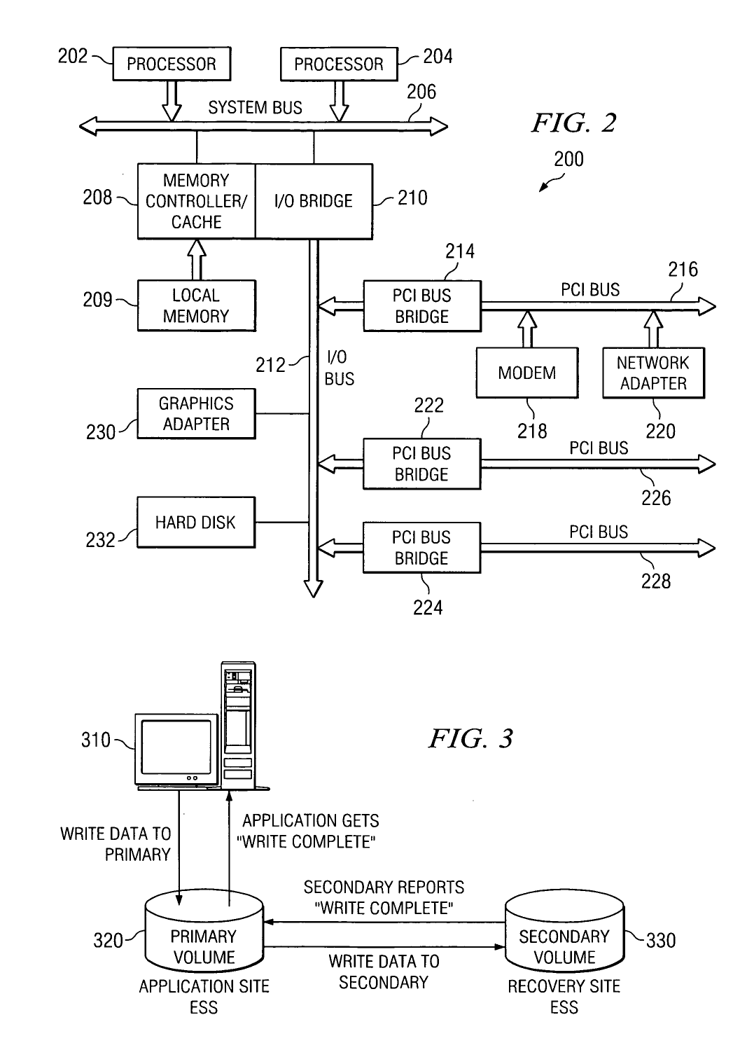

In the following description, the mechanisms of the illustrative embodiments will be described in terms of a distributed data processing environment in which there are a network of data processing systems provided that may communicate with one another via one or more networks and communication links. FIGS. 1 and 2 provide examples of data processing environments in which aspects of the illustrative embodiments may be implemented. The depicted data processing environments are only exemplary and are not intended to state or imply any limitation as to the types or configurations of data processing environments in which the exemplary aspects of the illustrative embodiments may be implemented. Many modifications may be made to the data processing environments depicted in FIGS. 1 and 2 without departing from the spirit and scope of the present invention.

With reference now to the figures, FIG. 1 depicts a pictorial representation of a network of data processing systems 100 in which the present invention may be implemented. Network data processing system 100 contains a local area network (LAN) 102 and a large area data network 130, which are the media used to provide communication links between various devices and computers connected together within network data processing system 100. LAN 102 and large area data network 130 may include connections, such as wired communication links, wireless communication links, fiber optic cables, and the like.

In the depicted example, server computing devices 102-105 are connected to LAN 102. The server computing devices 102-105 may comprise a storage area network (SAN) or a server cluster 120, for example. SANs and server clusters are generally well known in the art and thus, a more detailed explanation of SAN/cluster 120 is not provided herein.

In addition to server computing devices 102-105, clients 108, 110, and 112 are connected to LAN 102. These clients 108, 110, and 112 may be, for example, personal computers, workstations, application servers, or the like. In the depicted example, server computing devices 102-105 may store, track, and retrieve data objects for clients 108, 110 and 112. Clients 108, 110, and 112 are clients to server computing devices 102-105 and thus, may communication with server computing devices 102-105 via the LAN 102 to run applications on the server computing devices 102-105 and obtain data objects from these server computing devices 102-105. Network data processing system 100 may include additional servers, clients, and other devices not shown.

In addition to the LAN 102, the network data processing system 100 includes large area data network 130 that is coupled to the LAN 102. In the depicted example, the large area data network 130 may be the Internet, representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages.

It should be noted that the Internet is typically used by servers in a cluster to communicate with one another using TCP/IP for messaging traffic. Storage controllers participating in mirroring, such as PPRC as discussed hereafter, typically communicate over a separate storage network using FICON channel commands, SCSI commands, or TCP/IP.

Of course, large area data network 130 may also be implemented as a number of different types of networks, such as for example, an intranet, another local area network (LAN), a wide area network (WAN), or the like. FIG. 1 is only intended as an example, and is not intended to state or imply any architectural limitations for the illustrative embodiments described herein.

Server computing device 140 is coupled to large area data network 130 and has an associated storage system 150. Storage system 150 is shown as being directly coupled to the server computing device 140 but, alternatively, may be indirectly accessed by the server computing device 140 via the large area data network 130 or another network (not shown). Server computing device 140 is topologically remotely located from the SAN/cluster 120. That is, server computing device 140 is not part of the SAN/cluster 120. Moreover, Server computing device 140 may be geographically remotely located from the SAN/cluster 120.

The illustrative embodiments described hereafter provide mechanisms for relocating running applications from the server computing devices 102-105 of the SAN/cluster 120 to the topologically remotely located server computing device 140. It should be appreciated that while the illustrative embodiments will be described in terms of relocation running applications from a SAN/cluster 120, the illustrative embodiments and the present invention are not limited to such. Rather, instead of the SAN/cluster 120, a single server computing device, or even client computing device, may be the source of a running application that is relocated to a topologically remotely located computing device (either server or client computing device), without departing from the spirit and scope of the present invention.

Referring now to FIG. 2, a block diagram of a data processing system that may be implemented as a server computing device, such as one or more of server computing devices 102-105 or server computing device 140 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 and/or other network coupled devices may be provided through modem 218 and/or network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pseries system, a product of International Business Machines Corporation in Armonk, N.Y., running the Advanced Interactive Executive (AIX) operating system or LINUX operating system.

Referring again to FIG. 1, with the mechanism of the illustrative embodiments, it is desirable to relocate running applications from one computing device to another in order to provide high availability and disaster recovery. In particular it may be beneficial to relocate a running application from a server computing device 102-105 to a topologically and/or geographically remotely located server computing device 140. The illustrative embodiments provide mechanisms that are capable of remotely copying application data and checkpoint metadata for a running application to a topologically and/or geographically remotely located computing device as well as instant copy the application data and checkpoint metadata in order to provide a point in time recovery checkpoint.

As discussed above, known mechanisms, such as VMotion™ and MetaCluster™ only permit relocation of running applications within a local topology, i.e. within SAN/cluster 120. With these known mechanisms, the computing devices to which running applications may be relocated must have access to the same shared storage system, thereby limiting relocation to a local topology and geographical area. The known mechanisms do not permit relocation of running applications to topologically and/or geographically remotely located computing devices.

With the mechanisms of the illustrative embodiments, when a running application is to be relocated from, for example, the server computing device 102 to the topologically remotely located server computing system 140, the server computing device 102 copies the application data for the running application to the storage system 150 associated with the topologically remotely located server computing system 140. The copying of application data may be performed using a peer-to-peer remote copy operation, for example. This application data may further be copied to an instant copy, or flash copy, storage medium 160 in order to generate a copy of application data for a recovery time point for the application, i.e. a recovery checkpoint.

As mentioned above, being topologically remotely located, in the present description, refers to the server computing system 140 being outside the SAN/cluster 120 of the server computing device 102 from which the running application is being relocated. In many cases a topologically remotely located server computing system 140 may be geographically remotely located as well, but this is not required for the server computing system 140 to be topologically remotely located. Rather, the topologically remotely located server computing system 140 need only be remotely located in terms of the network topology of the network data processing system 100 connecting the various computing devices.

In addition to copying the application data to the topologically remotely located server computing system 140, the server computing device 102 also generates a stateful checkpoint of the running application and stores the checkpoint data to a storage medium associated with the server computing device 102. The stateful checkpoint comprises a set of metadata describing the current state of the running application at the time that the checkpoint is generated. Preferably, the checkpoint is generated at substantially the same time as the copying of the application data so as to ensure that the state of the application as represented by the checkpoint metadata matches the application data.

The checkpoint metadata may be copied to the same or different storage system 150 associated with the topologically remotely located computing system in a similar manner as the application data. For example, a peer-to-peer remote copy operation may be performed on the checkpoint metadata to copy the checkpoint metadata to the remotely located storage system 150. This checkpoint metadata may further be copied to the instant copy, or flash copy, storage medium 160 in order to generate a copy of checkpoint metadata for a recovery time point for the application.

In one illustrative embodiment, the MetaCluster ™ product may be used to generate checkpoint metadata for the running application as if the application were being relocated within the local cluster 120 of server computing devices 102-105. In such an illustrative embodiment, the checkpoint metadata and application data may be relocated to a topologically remotely located server computing system 140 using the Peer-to-Peer Remote Copy (PPRC) or Peer-to-Peer Remote Copy Extended Distances (PPRC-XD) product available from International Business Machines, Inc. of Armonk, N.Y. The recovery time point copies of the application data and checkpoint metadata may be generated, for example, using the FlashCopy™ product available from International Business Machines, Inc.

The MetaCluster™, PPRC, PPRC-XD, and FlashCopy™ products are generally known in the art. Information regarding the MetaCluster™ product may be found, for example, in the articles “Meiosys Releases MetaCluster UC Version 3.0” and “Meiosys Relocates Multi-Tier Applications Without Interruption of Service,” available from the PR Newswire website (www.prnewswire.com). Information regarding the PPRC and PPRC-XD products are described, for example, in the Redbooks paper entitled “IBM TotalStorage Enterprise Storage Server PPRC Extended Distance,” authored by Castets et al., and is available at the official website for International Business Machines, Inc. (www.ibm.com). The FlashCopy product is described, for example, in the Redbook paper entitled “IBM TotalStorage PPRC Migration Manager and FlashCopy Manager Overview,” authored by Warrick et al., and is available at the official website for International Business Machines, Inc. (www.ibm.com). These documents are hereby incorporated herein by reference.

FIG. 3 is an exemplary block diagram illustrating the peer-to-peer remote copy operation in accordance with one illustrative embodiment. In the depicted example, the PPRC-XD product is used to perform the peer-to-peer remote copy operation, although the present invention is not limited to using PPRC or PPRC-XD. Rather, any mechanism that permits the remote copying of data and metadata to a topologically remotely located storage system may be used without departing from the spirit and scope of the present invention.

Using PPRC-XD as representative of one illustrative embodiment for performing remote copying of data and metadata, PPRC is an Enterprise Storage Server (ESS) function that allows the shadowing of application system data from one site (referred to as the application site) to a second site (referred to as the recovery site). The logical volumes that hold the data in the ESS at the application site are referred to as primary volumes and the corresponding logical volumes that hold the mirrored data at the recovery site are referred to as secondary volumes. In one illustrative embodiment, the connection between the primary and the secondary ESSs may be provided using Enterprise Systems Connection (ESCON) links.

FIG. 3 illustrates the sequence of a write operation when operating PPRC in synchronous mode (PPRC-SYNC). As shown in FIG. 3, in this synchronous type of operation, the updates done to the application site primary volumes 320 are synchronously shadowed onto the secondary volumes 330 at the recovery site. Because this is a synchronous solution, write updates are ensured on both copies (primary and secondary) before the write is considered to be completed for the application running on the computing device 310.

Because in PPRC-SYNC operation the application does not get the “write complete” condition until the update is synchronously done in both the primary and the secondary volumes 320 and 330, from the application perspective, the data at the recovery site secondary volumes 330 is real time data that is always consistent with the data at the primary volumes 320.

One implication of this characteristic is that, in normal PPRC-SYNC operation, dependent writes are applied on the secondary volumes 330 in the same sequence as they are applied in the primary volumes 320. This is very important from an application consistency perspective at the time of the recovery. PPRC-SYNC can provide continuous data consistency at the recovery site without needing to periodically interrupt the application to build consistency checkpoints. From the application perspective this is a non-disruptive way of always having valid data at the recovery location.

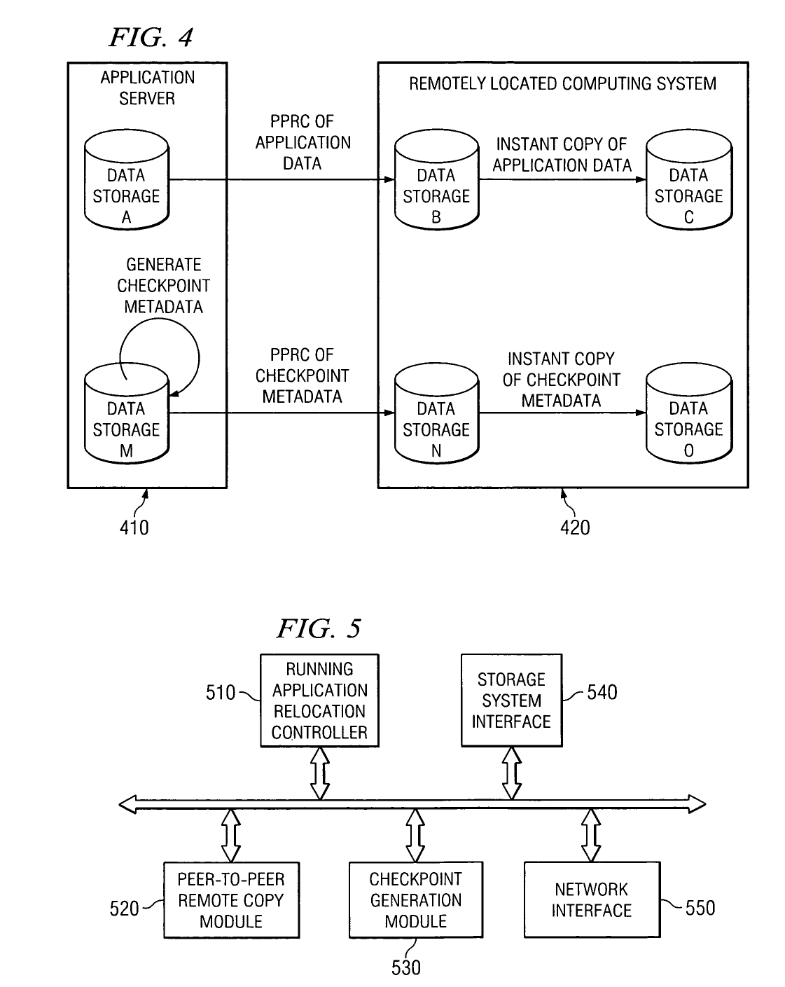

While a synchronous PPRC operation is illustrated in FIG. 3, it should be appreciated that the mechanisms of the illustrative embodiments may be equally applicable to both synchronous and asynchronous remote copy operations. In an asynchronous remote copy operation, the “write complete” may be returned from the primary volumes 320 prior to the data being committed in the secondary volumes 330. Essentially, with regard to the asynchronous remote copy operations of the illustrative embodiments herein, instant copy source storage devices, as discussed hereafter, need to be at a data-consistent state prior to the instant copy operation being performed. Exemplary operations for ensuring such data-consistency will be described hereafter with reference to FIG. 4.

The illustrative embodiments make use of a remote copy operation, which in the preferred embodiments is a peer-to-peer remote copy operation such as is provided by PPRC and PPRC-XD, to write remote copies of application data and checkpoint metadata to a storage system associated with a topologically remotely located computing system. FIG. 4 is an exemplary diagram illustrating an operation for relocating a running application in accordance with one illustrative embodiment.

As shown in FIG. 4, when a running application is to be relocated to a topologically remotely located server computing system, hereafter referred to as the remote server 420, the server computing device on which the application is running, hereafter referred to as the application server 410, writes a remote copy of the application data to a storage system associated with the remote server 420. In the depicted example, application data, which may comprise the outbound data of the running application, for example, is present in data storage A of the application server 410 and is written, through a remote copy operation, to data storage B of the remote server 420.

In addition to remote copying the application data, the application server 410 generates a checkpoint for the running application. The metadata for the checkpoint is stored, in the depicted example, in data storage M which may or may not be in the same storage system as data storage A. The checkpoint is preferably generated as substantially the same time as the remote copy of the application data to the data storage B. This helps to ensure that the state of the running application represented by the checkpoint metadata matches the application data copied to the data storage B.

The checkpoint metadata is remotely copied to the data storage N. Again, this remote copying may be performed using a peer-to-peer remote copy operation such as is provided by PPRC or PPRC-XD, for example. Data storage N may or may not be in the same storage system as data storage B. At this point, data storage B and data storage N comprise all of the information necessary for recreating the state of the running application on the remote server 420. Using this data and metadata, the application may be initiated and the state of the application set to the state represented by the checkpoint metadata. In this way, the running application may be relocated from application server 410 to remote server 420.

In addition, instant or flash copies of the application data in data storage B and the checkpoint metadata in data storage N may be made so as to provide a recovery checkpoint. As shown in FIG. 4, an instant or flash copy of the application in data storage B may be made to data storage C. Similarly, an instant or flash copy of the checkpoint metadata in data storage N may be made to data storage O. Data storages C and O are preferably in the same storage system and may or may not be in the same storage system as data storage B and N.

It should be appreciated, as mentioned previously, that the remote copy operations described above may be performed using a synchronous or asynchronous mirroring operation, i.e. remote copy operation. With synchronous mirroring, the data stored in storage device A will always be identical to the data stored in storage device B. Similarly, the data stored in storage device M will be identical to the data stored in storage device N. When an application checkpoint is generated, the state of storage device B is preserved in storage device C using an instant copy operation. Then, when the checkpoint state metadata is written to storage device M, it is essentially also written to storage device N due to the synchronous mirroring. At this time, storage device C matches the same logical point in time as storage device N which may or may not be copied to storage device O to preserve that state, depending upon the implementation.

There are two ways in which asynchronous mirroring may be performed. One way is to preserve the original order of updates which maintains the consistency of the data on the storage devices at any point in time. The other way is to not maintain the update order but to optimize transmission of data to achieve the highest bandwidth (referred to as a “non-synchronous” operation).

PPRC-XD implements a non-synchronous operation. Thus, to ensure consistency within the storage devices one of two methods may be used. One method is to query the storage controllers associated with the storage devices involved to determine if all the changed data on the source storage devices has been replicated. If all data has been replicated then the mirrored pairs in the storage devices are identical and an instant copy would create a consistent set of data on storage device C or O. Otherwise, it would be necessary to wait until all changed data was replicated before performing the instant copy operation. This method is best suited for applications where data is not changing on a real time basis.

The other method is to instruct the storage controller(s) to change from non-synchronous replication to synchronous. When this is done, a situation similar to the synchronous operation described above is generated and an instant copy operation may be performed. After the instant copy operation is performed, the mirroring operation may be changed back to non-synchronous to optimize data transmission. This method is utilized in the preferred embodiments of the illustrative embodiments, but the present invention is not limited to this particular methodology. Other methods than those described herein may be used without departing from the spirit and scope of the present invention so long as the data-consistency of the source storage devices is ensured prior to performing the instant copy operation.

FIG. 5 is an exemplary block diagram of the primary operational components of a running application relocation mechanism in accordance with an illustrative embodiment. The elements shown in FIG. 5 may be implemented in hardware, software, or any combination of hardware and software. In a preferred embodiment, the elements shown in FIG. 5 are implemented as software instructions executed by one or more processors. However, it should be appreciated that one or more dedicated hardware devices may be provided for implementing the functionality of the elements in FIG. 5.

As shown in FIG. 5, the running application relocation mechanism 500 comprises a running application relocation controller 510, a peer-to-peer remote copy module 520, a checkpoint generation module 530, a storage system interface 540, and a network interface 550. These elements are preferably provided in a computing device in which a running application is to be relocated to a topologically remotely located computing device. However, in an alternative embodiment, these elements may be provided in a separate computing device that communicates with computing devices running applications that are to be relocated to other topologically remotely located computing devices, e.g., the elements may be provided in a proxy server, cluster or SAN control computing device, or the like.

The running application relocation controller 510 controls the overall operation of the running application relocation mechanism 500 and orchestrates the operation of the other elements 520-550. The running application relocation controller 510 contains the overall instructions/functionality for performing relocation of running applications to a topologically remotely located computing device. The running application relocation controller 510 communicates with each of the other elements 520-550 to orchestrate their operation and interaction.

The peer-to-peer remote copy module 520 performs remote copy operations to topologically remotely located computing devices of application data and checkpoint metadata obtained via the storage system interface 540. The peer-to-peer remote copy module 520 may implement, in one illustrative embodiment, the PPRC or PPRC-XD product previously described above, for example.

The application data is generated as the running application executes and thus, a separate module is not necessary for generating the application data. However, a checkpoint generation module 530 is provided for generating checkpoint metadata for use in relocating the running application. This checkpoint generation module 530 may, in one illustrative embodiment, implement the MetaCluster™ product previously described above, for example. The checkpoint metadata may be stored to an associated storage system via the storage system interface 540 and may then be remotely copied along with the application data to a topologically remotely located computing device using the peer-to-peer remote copy module 520. The remote copy operations may be performed on the topologically remotely located computing device via the network interface 550, for example.

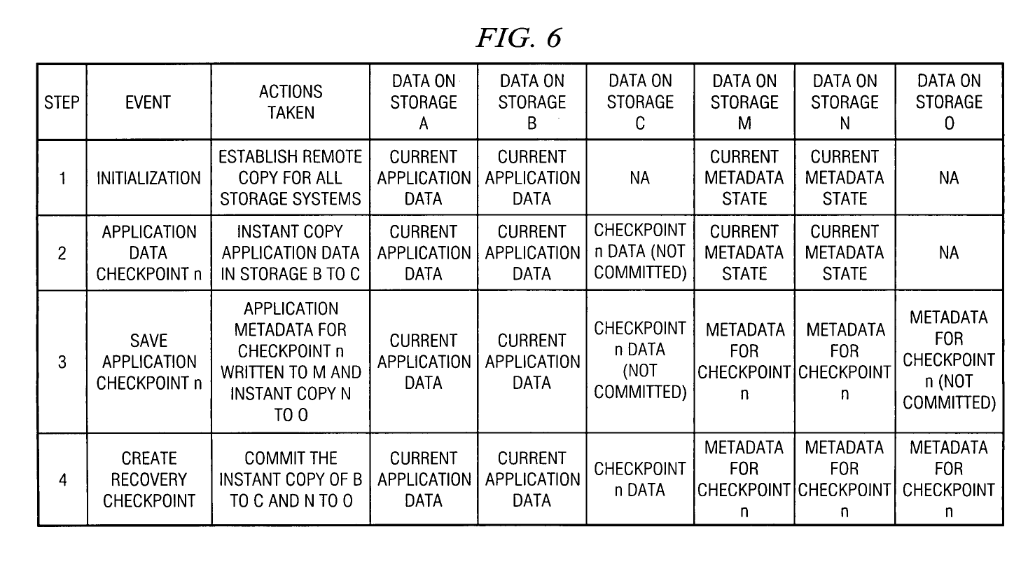

FIG. 6 is an exemplary table illustrating the primary steps in performing a relocation of a running application in accordance with an illustrative embodiment. The example shown in FIG. 6 assumes a configuration of storage devices as previously shown in FIG. 4. Thus, reference to data storages A-C and M-O in FIG. 6 are meant to refer to similar data storages shown in FIG. 4.

As shown in FIG. 6, a first step in the running application relocation operation is to perform initialization. This initialization operation is used to establish the remote copy operation for all storage systems that are to be part of the running application relocation operation. This initialization operation may take different forms depending upon the particular types of storage controllers of the storage devices involved in the operation. Generally speaking, the source storage controller is configured to be able to route data over the network to a target storage controller. This is done by establishing a path between the source and target storage controllers. After the path is established, the storage volumes that comprise the data that is being remotely copied are defined and the remote copy operation is started. The type of remote copy operation, i.e., synchronous or asynchronous, is defined when the storage volumes that are part of the remote copy operation are defined.

At initialization, storage devices A and B store the current application data for the running application and storage C does not store any data associated with the application relocation operation. Storage device B stores the current application data by virtue of the operation of the peer-to-peer remote copy module which, as shown in FIG. 3, writes application data to both the primary volume and the secondary volume in a synchronous or asynchronous manner.

Storage devices M and N store the current metadata state for the running application. Again, storage device N stores the current metadata state for the running application by virtue of the operation of the peer-to-peer remote copy module. Storage device O and storage device C do not yet contain any data associated with the application relocation operation.

In a second step of the relocation operation, an application data checkpoint n is generated. The actions take to generate this application data checkpoint n are the instant or flash copy of application data in storage device B to storage device C. Thus, storage devices A and B contain the current application data for the running application and storage device C contains the application data for checkpoint n which has not yet been committed. Storage devices M, N and O have not changed from the initialization step.

In a third step of the relocation operation, the application checkpoint n is saved. This involves writing application metadata for checkpoint n to data storage M, and thus, storage device N, and then instant or flash copying the application metadata to storage O. Thus, storage devices M, N and O store metadata for checkpoint n. The instant copy of the checkpoint metadata in storage O is not yet committed. The state of the storage devices A, B and C has not changed in this third step.

In a fourth step of the relocation operation, a recovery checkpoint is created by committing the instant or flash copies of the application data and checkpoint metadata in storage devices C and O. As a result, storage devices A and B have the current application data and storage device C has the checkpoint n application data. Storage devices M, N and O all contain the metadata for checkpoint n.

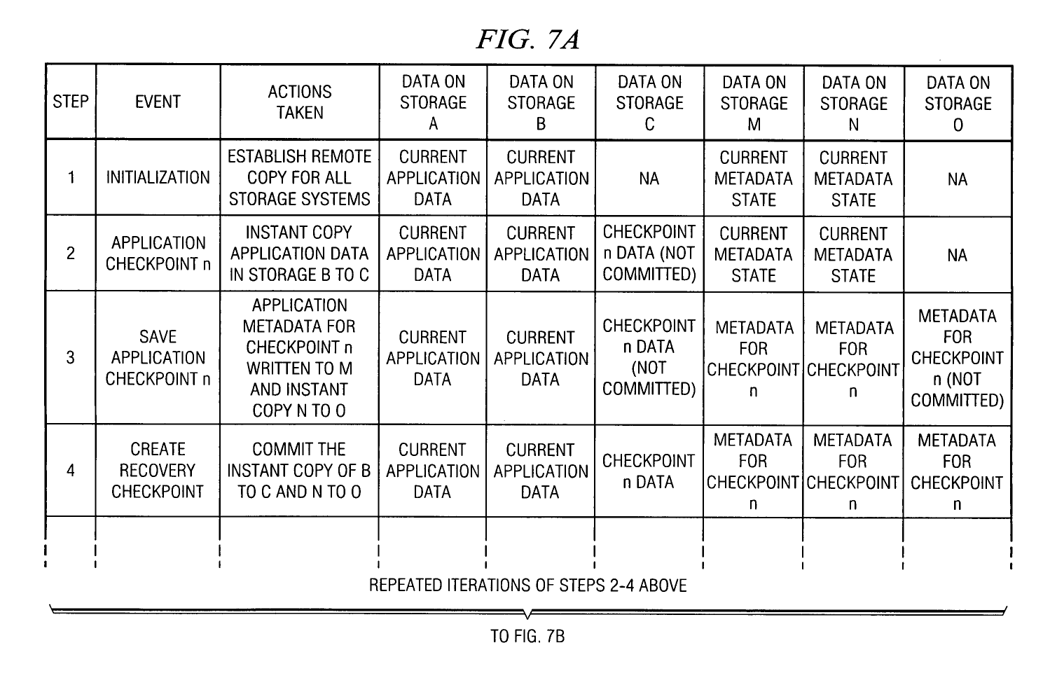

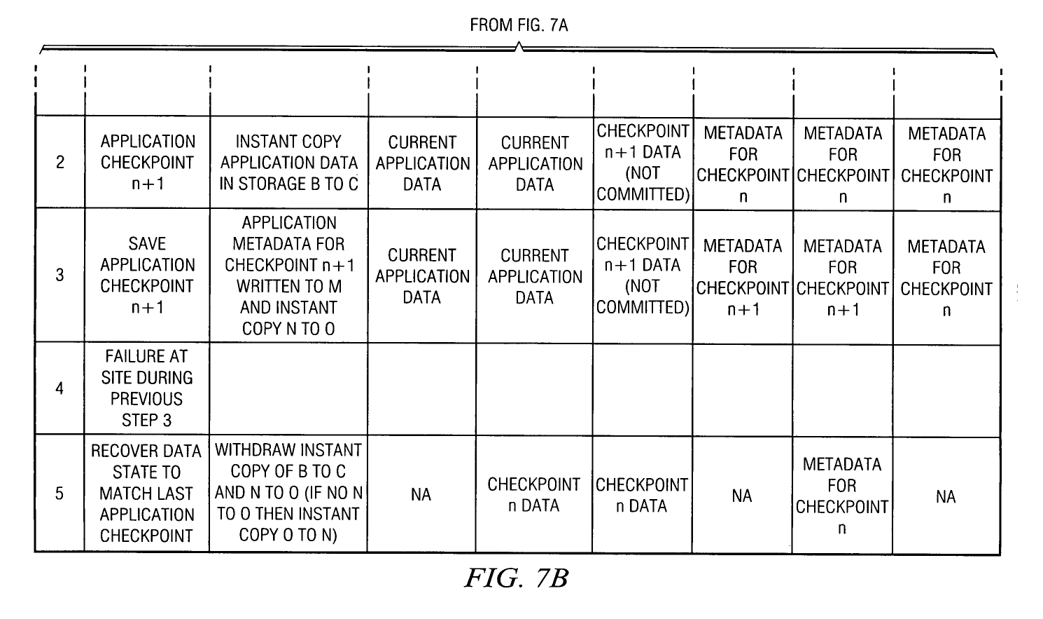

An application may be migrated/replicated directly at step four for high availability purposes if the application is paused (no update activity between steps 2 and 4) with no data loss. For disaster recovery, however, it may be necessary to synchronize the application data state on storage device B with the application metadata state on storage device N. Such an operation is outlined in FIGS. 7A and 7B hereafter.

FIGS. 7A and 7B are an exemplary table illustrating the primary steps in recovering a last checkpoint of a running application in response to a failure during a relocation operation in accordance with an illustrative embodiment. Steps 1-4 of FIG. 7A may be repeated without any failure a number of times. However, at some point a failure may occur during the relocation operation. This situation is illustrated in steps 32-35 shown at the bottom of FIG. 7B.

As shown in FIG. 7B, steps 32 and 33 may be performed in a similar manner as previously described above with regard to FIG. 6 but for a new checkpoint n+1. During step 33, a failure may occur at the topologically remotely located computing device. As a consequence, the state of the running application at the remotely located computing device must be reverted back to a last application checkpoint, in this case checkpoint n.

In step 35, the data state of the application is recovered to match the last application checkpoint. This involves withdrawing the instant or flash copy of storage device B to storage device C and storage device N to storage device O. As a result, storage device B and storage device C contain application data for checkpoint n and storage device N contains checkpoint metadata for checkpoint n. This data may be used to reset the running application to a state corresponding to checkpoint n. Thus, in addition to providing a mechanism for remotely relocating running applications to topologically remotely located computing devices, the illustrative embodiments provide a mechanism for performing such remote relocation while providing for disaster or failure recovery.

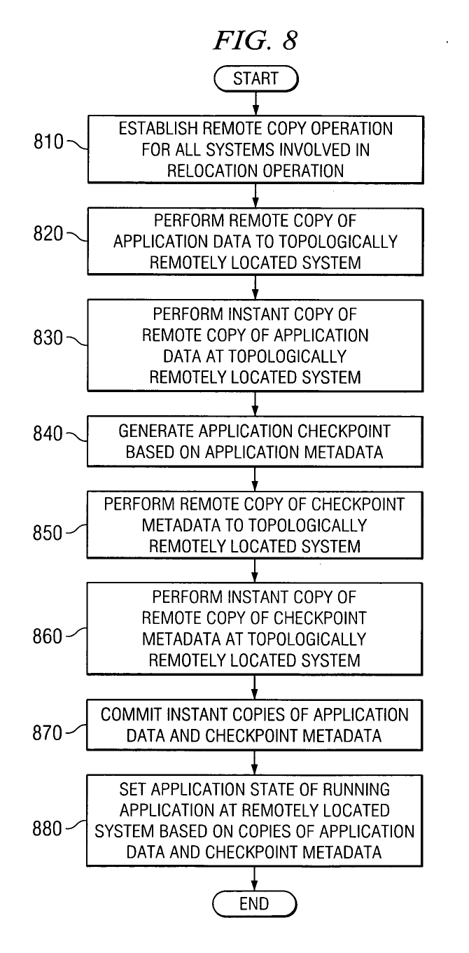

FIG. 8 is a flowchart outlining an exemplary operation for relocating a running application to a topologically remotely located computing system in accordance with an illustrative embodiment. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

As shown in FIG. 8, the operation starts by establishing a remote copy operation for all storage/computing systems involved in the relocation operation (step 810). A remote copy of the application data is performed to the topologically remotely located system (step 820). An instant or flash copy of the application data at the topologically remotely located system is performed (step 830).

An application checkpoint is generated based on application metadata (step 840) and a remote copy of the checkpoint metadata is performed to the topologically remotely located system (step 850). An instant or flash copy of the checkpoint metadata at the topologically remotely located system is performed (step 860). Step 860 is logically associated with step 830 because together they represent the combined state of the running application and the current state of its data.

The instant or flash copies of the application data and checkpoint metadata are then committed (step 870). An application state of the running application at the topologically remotely located system is then set based on the copies of the application data and checkpoint metadata (step 880). The operation then terminates.

The commit process in step 870 is what finally associates steps 830 and 860. If step 830 is performed but step 860 is not performed, then, for example, storage device C in FIG. 4 would be at an n+1 state and storage device O would be at an n state. Thus, if recovery had to take place at this time, the instant copy on storage device C would need to be withdrawn, as previously described, so that recover would be from checkpoint n.

Thus, the illustrative embodiments provide mechanisms for relocating running applications to topologically remotely located computing systems. The mechanisms of the illustrative embodiments overcome the limitations of the known relocation mechanisms by providing an ability to relocate running applications to computing systems outside a local storage area network and/or cluster. With the mechanisms of the illustrative embodiments, running applications may be relocated to topologically and/or geographically remotely located computing systems in such a manner that disaster and failure recovery is made possible.

The illustrative embodiments as described above may take the form of an entirely hardware embodiment, an entirely software embodiment or an embodiment containing both hardware and software elements. In a preferred embodiment, the invention is implemented in software, which includes but is not limited to firmware, resident software, microcode, and the like.

Furthermore, the illustrative embodiments may take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

As described previously above with regard to FIG. 2, a data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the illustrative embodiments has been presented for purposes of illustration and description, and is not intended to be exhaustive or limited to the invention in the form disclosed. Many modifications and variations will be apparent to those of ordinary skill in the art. The embodiments were chosen and described in order to best explain the principles of the illustrative embodiments of the invention, the practical application, and to enable others of ordinary skill in the art to understand the invention for various illustrative embodiments with various modifications as are suited to the particular use contemplated.

What is claimed is:

1. A computer program product comprising a computer usable medium having a computer readable program, wherein the computer readable program, when executed on a computing device, causes the computing device to:
remotely copy application data for a running application to a topologically remotely located computing system;
generate an application checkpoint comprising checkpoint metadata that represents a same point in time as the copy of the application data;
remotely copy the checkpoint metadata to the topologically remotely located computing system; and
relocate the running application to the topologically remotely located computing system by initiating the running application on the topologically remotely located computing system using the copy of the application data and the checkpoint metadata.

2. The computer program product of claim 1, wherein the computer readable program causes the computing device to remotely copy application data to a topologically remotely located computing system and remotely copy the checkpoint metadata to the topologically remotely located computing system using a peer-to-peer remote copy operation.

3. The computer program product of claim 2, wherein the peer-to-peer remote copy operation is an asynchronous copy operation.

4. The computer program product of claim 2, wherein the peer-to-peer remote copy operation is a non-synchronous asynchronous copy operation.

5. The computer program product of claim 1, wherein the topologically remotely located computing system is geographically remotely located from a source computing system that initially is running the running application.

6. The computer program product of claim 1, wherein the remotely copied application data and remotely copied checkpoint metadata are copied from a storage system associated with the topologically remotely located computing system to at least one other storage device to generate a recovery checkpoint.

7. The computer program product of claim 6, wherein the copying of the remotely copied application data and checkpoint metadata to at least one other storage device is performed using an instant copy operation.

8. The computer program product of claim 6, wherein the topologically remotely located computing system queries storage controllers associated with a source computing system from which the application data and checkpoint metadata are remotely copied and the topologically remotely located computing system to determine if all of the application data and checkpoint metadata has been remotely copied, and wherein the topologically remotely located computing system performs the copying of the remotely copied application data to the at least one other storage device only if all of the application data has been remotely copied to the topologically remotely located computing system, and wherein the topologically remotely located computing system performs the copying of the remotely copied checkpoint metadata to the at least one other storage device only if all of the checkpoint metadata has been remotely copied to the topologically remotely located computing system.

9. The computer program product of claim 6, wherein the computer readable program further causes the computing device to:
detect a failure of the topologically remotely located computing device during a remote copy operation; and
recover a state of the running application at a last checkpoint based on the remotely copied application data and remotely copied checkpoint metadata present in storage devices associated with the topologically remotely located computing device.

10. The computer program product of claim 1, wherein the computing device generates the application checkpoint at substantially a same time as when the computing device remotely copies the application data for the running application.

11. The computer program product of claim 1, wherein the computing device is one of a storage area network control computing device or a server cluster control computing device.

12. The computer program product of claim 1, wherein the computer readable program causes the computing device to repeatedly perform the operations of remotely copying application data for a running application to a topologically remotely located computing system, generating an application checkpoint comprising checkpoint metadata that represents a same point in time as the copy of the application data, and remotely copying the checkpoint metadata to the topologically remotely located computing system.

13. An apparatus, comprising:
a processor; and
a memory coupled to the processor, wherein the memory contains instructions which, when executed by the processor, cause the processor to:
remotely copy application data for a running application to a topologically remotely located computing system;
generate an application checkpoint comprising checkpoint metadata that represents a same point in time as the copy of the application data;
remotely copy the checkpoint metadata to the topologically remotely located computing system; and
relocate the running application to the topologically remotely located computing system by initiating the running application on the topologically remotely located computing system using the copy of the application data and the checkpoint metadata.

14. The apparatus of claim 13, wherein the instructions cause the processor to remotely copy application data to a topologically remotely located computing system and remotely copy the checkpoint metadata to the topologically remotely located computing system using a peer-to-peer remote copy operation.

15. The apparatus of claim 14, wherein the peer-to-peer remote copy operation is an asynchronous copy operation.

16. The apparatus of claim 14, wherein the peer-to-peer remote copy operation is a non-synchronous asynchronous copy operation.

17. The apparatus of claim 13, wherein the topologically remotely located computing system is geographically remotely located from the apparatus that initially is running the running application.

18. The apparatus of claim 13, wherein the remotely copied application data and remotely copied checkpoint metadata are copied from a storage system associated with the topologically remotely located computing system to at least one other storage device to generate a recovery checkpoint.

19. The apparatus of claim 18, wherein the copying of the remotely copied application data and checkpoint metadata to at least one other storage device is performed using an instant copy operation.

20. The apparatus of claim 18, wherein the topologically remotely located computing system queries storage controllers associated with a source computing system from which the application data and checkpoint metadata are remotely copied and the topologically remotely located computing system to determine if all of the application data and checkpoint metadata has been remotely copied, and wherein the topologically remotely located computing system performs the copying of the remotely copied application data to the at least one other storage device only if all of the application data has been remotely copied to the topologically remotely located computing system, and wherein the topologically remotely located computing system performs the copying of the remotely copied checkpoint metadata to the at least one other storage device only if all of the checkpoint metadata has been remotely copied to the topologically remotely located computing system.

21. The apparatus of claim 18, wherein the instructions further cause the processor to:
detect a failure of the topologically remotely located computing device during a remote copy operation; and
recover a state of the running application at a last checkpoint based on the remotely copied application data and remotely copied checkpoint metadata present in storage devices associated with the topologically remotely located computing device.

22. The apparatus of claim 13, wherein the processor generates the application checkpoint at substantially a same time as when the computing device remotely copies the application data for the running application.

23. The apparatus of claim 13, wherein the apparatus is part of one of a storage area network control computing device or a server cluster control computing device.

24. The apparatus of claim 13, wherein the instructions cause the processor to repeatedly perform the operations of remotely copying application data for a running application to a topologically remotely located computing system, generating an application checkpoint comprising checkpoint metadata that represents a same point in time as the copy of the application data, and remotely copying the checkpoint metadata to the topologically remotely located computing system.

25. A method, in a data processing system, for relocating a running application from a source computing device to a topologically remotely located computing system, comprising:
remotely copying application data for a running application on the source computing device to the topologically remotely located computing system;
generating an application checkpoint comprising checkpoint metadata that represents a same point in time as the copy of the application data;
remotely copying the checkpoint metadata to the topologically remotely located computing system; and
relocating the running application to the topologically remotely located computing system by initiating the running application on the topologically remotely located computing system using the copy of the application data and the checkpoint metadata.

26. The method of claim 25, wherein the remotely copying application data to a topologically remotely located computing system and remotely copying the checkpoint metadata to the topologically remotely located computing system comprises using a peer-to-peer remote copy operation.

27. The method of claim 26, wherein the peer-to-peer remote copy operation is an asynchronous copy operation.

28. The method of claim 25, wherein the topologically remotely located computing system is geographically remotely located from a source computing system that initially is running the running application.

29. The method of claim 25, further comprising:
copying the remotely copied application data and remotely copied checkpoint metadata from a storage system associated with the topologically remotely located computing system to at least one other storage device to generate a recovery checkpoint.

30. The method of claim 29, wherein copying the remotely copied application data and checkpoint metadata to at least one other storage device comprises using an instant copy operation.

31. The method of claim 29, further comprising:
querying storage controllers associated with the source computing device and the topologically remotely located computing system to determine if all of the application data and checkpoint metadata has been remotely copied, wherein the copying of the remotely copied application data to the at least one other storage device is performed only if all of the application data has been remotely copied to the topologically remotely located computing system, and wherein the copying of the remotely copied checkpoint metadata to the at least one other storage device is performed only if all of the checkpoint metadata has been remotely copied to the topologically remotely located computing system.

32. The method of claim 29, further comprising:
detecting a failure of the topologically remotely located computing device during a remote copy operation; and
recovering a state of the running application at a last checkpoint based on the remotely copied application data and remotely copied checkpoint metadata present in storage devices associated with the topologically remotely located computing device.

33. The method of claim 25, wherein the application checkpoint is generated at substantially a same time as the remote copying of the application data for the running application.

34. The method of claim 25, further comprising:
repeatedly perform the operations of remotely copying application data for a running application to a topologically remotely located computing system, generating an application checkpoint comprising checkpoint metadata that represents a same point in time as the copy of the application data, and remotely copying the checkpoint metadata to the topologically remotely located computing system.

35. A system for relocating a running application, comprising:
at least one network;
a first computing system coupled to the network; and
a second computing system coupled to the network, wherein the second computing system is topologically remotely located from the first computing system, and wherein the first computing system:
remotely copies application data for a running application on the first computing system to the second computing system;
generates an application checkpoint comprising checkpoint metadata that represents a same point in time as the copy of the application data;
remotely copies the checkpoint metadata to the second computing system; and
relocates the running application to the second computing system by initiating the running application on the second computing system using the copy of the application data and the checkpoint metadata.
